(19) United States
(12) Patent Application Publication
(10) Pub. No.: US 2022/0314865 A1
(43) Pub. Date: Oct. 6, 2022

(54) MOTOR VEHICLE DECK

(71) Applicant: Samuel Westlind, Bozeman, MT (US)

(72) Inventor: Samuel Westlind, Bozeman, MT (US)

(21) Appl. No.: 17/703,054

(22) Filed: Mar. 24, 2022

Related U.S. Application Data
(60) Provisional application No. 63/171,417, filed on Apr. 6, 2021.
(60) Provisional application No. 63/239,750, filed on Sep. 1, 2021.
(60) Provisional application No. 63/272,559, filed on Oct. 27, 2021.
(60) Provisional application No. 63/287,474, filed on Dec. 8, 2021.

(51) Int. Cl. B60P 3/34; B60P 3/36; B60J 5/10

(52) U.S. Cl. CPC B60P 3/34; B60P 3/36; B60J 5/101

(57) ABSTRACT

A modular vehicle system configured to improve storage of a vehicle including one or more rear doors, including at least one modular column configured to provide a vertical surface for mounting various attachments thereto, the at least one column including a first component and a second component, wherein the first component and the second component are slidable relative to one another to span a distance between a floor of the vehicle and a ceiling of the vehicle inside of the one or more rear doors.

### RELATED APPLICATION INFORMATION

This application claims the benefit of U.S. Provisional Application Nos. 63/171,417 (filed Apr. 6, 2021), 62/239,750 (filed Sep. 1, 2021), 63/272,559 (filed Oct. 27, 2021), and 63/287,474 (filed Dec. 8, 2021), the contents of which are fully incorporated herein by reference.

### TECHNICAL FIELD

The present technology is generally related to accessories for vehicles having a livable space, and more particularly to modular systems configured to improve storage and generally expand the livable space in a camper van or other vehicle.

### BACKGROUND

Vandwelling or vanlife is a lifestyle of living in a vehicle full or part-time that allows for significant autonomy and a generally lower cost-of-living than having a mortgage or lease for conventional stationary housing. In 2020, in the midst of the COVID-19 pandemic, an idealized version of vandwelling was popularized through social media with the hashtag “#vanLife.”

Much of the appeal of vanlife centers on seeking freedom and self-sufficiency. By being completely mobile, vandwellers are free to travel as much or little as they would like. For example, some vandwellers may choose to remain in one general area and work full-time or attend school while living in their vehicles. Others may travel full-time while working remotely via the Internet or finding seasonal or short-term employment opportunities in various locations. Still others may enjoy vandwelling primarily on weekend and recreational outings, as opposed to sleeping in a tent or other more temporary shelter.

Although the term vandwelling implies living in a van, many types of vehicles may be used for mobile living arrangements, including, class A, B, and C campervans, recreational vehicles (RVs), former public buses or school buses (“skoolies”), travel trailers, and other types of mobile homes. Since vandwelling consists of living in a vehicle with a footprint no larger than a parking space, space is often an issue.

In particular, many vehicles are limited in their usable living space by design, as larger living spaces generally come at the cost of more difficult to operate, less efficient vehicles, which can negatively interfere with the freedom to travel. During travel and for security reasons, much of the limited living space with the vehicle can be consumed for storage (e.g., bikes, skis, snowboards, outdoor chairs, and other cargo). Although various carriers for the backs or roofs of these vehicles have been developed, cargo stored on an exterior of the vehicle can create a significant amount of noise and aerodynamic drag, which can negatively impact gas mileage. Moreover, in addition to being a target of potential theft, the cargo is exposed to the elements and road grime while stored.

The present disclosure addresses these concerns.

### SUMMARY OF THE DISCLOSURE

One embodiment of the present disclosure provides modular vehicle system configured to improve storage of a vehicle including one or more rear doors, the modular vehicle system including at least one modular column configured to provide a vertical surface for mounting various attachments thereto, the at least one column including a first component and a second component, wherein the first component and the second component are slidable relative to one another to span a distance between a floor of the vehicle and a ceiling of the vehicle inside of the one or more rear doors.

Another embodiment of the present disclosure provides modular vehicle system configured to expand a livable space of a vehicle including one or more rear doors, the modular vehicle system including a deck assembly including a substantially rigid, planar deck plate pivotably coupleable to a rear of the vehicle inside of the one or more rear doors by a hinge assembly, wherein the deck plate is configured pivotably transition between a substantially horizontally orientated use position extending beyond the one or more rear doors to an exterior of the vehicle, and a substantially vertical oriented storage position inside of the one or more rear doors, wherein in the use position, the deck plate is supported by one or more tension members traversing from the deck plate to a rear portion of the vehicle above the deck plate.

Another embodiment of the present disclosure provides a modular vehicle system configured to improve storage and expand a livable space of a vehicle including one or more rear doors, the modular vehicle system including a pair of modular columns configured to provide vertical surfaces for mounting various attachments thereto, each of the modular columns including a first component and a second component, wherein the first component and the second component are slidable relative to one another to span a distance of at least 75 inches between a floor of the vehicle and a ceiling of the vehicle inside of the one or more rear doors; and a deck assembly including a substantially rigid, planar deck plate pivotably coupleable to a rear of the vehicle inside of the one or more rear doors by a hinge assembly, wherein the deck plate is configured pivotably transition between a substantially horizontally orientated use position extending beyond the one or more rear doors to an exterior of the vehicle, and a substantially vertical oriented storage position inside of the one or more rear doors aft of the pair of modular columns, wherein in the use position, the deck plate is supported by one or more tension members traversing from the deck plate to at least one of a rear portion of the vehicle or the pair of modular columns above the deck plate.

Another embodiment of the present disclosure provides a modular vehicle system configured to improve storage of a vehicle including one or more rear doors, the modular vehicle system including at least one modular column configured to provide a vertical surface for mounting various attachments thereto, the at least one column including a first component and a second component, wherein the first component and the second component are slidable relative to one another to span a distance between a floor of the vehicle and a ceiling of the vehicle inside of the one or more rear doors; and two or more substantially horizontally orientated rails configured to receive at least one recovery panels.

Another embodiment of the present disclosure provides a modular vehicle system configured to improve storage of a vehicle including one or more rear doors, the modular vehicle system including at least two modular columns configured to provide a vertical surface for mounting various attachments thereto, each modular column including a first component and a second component, wherein the first component and the second component are slidable relative to one another to span a distance between a floor of the vehicle and a ceiling of the vehicle inside of the one or more rear doors; and at least two horizontally oriented supports, the at least two horizontally oriented supports configured to provide rigidity and support to a bed platform.

In one embodiment, the first component and the second component are both constructed of and extruded metal, wherein a protrusion defined on an exterior of the first component is configured to be slidably received within a channel defined on an exterior of the second component, thereby restricting movement of the first and second components to an adjustment of overall length of the at least one column. In one embodiment, the first component and the second component are configured to be locked in position relative to one another by a locking member. In one embodiment, the system further includes at least one of a table mount or entertainment mount operably coupleable to the at least one column.

In one embodiment, the system further includes two or more substantially horizontally orientated rails configured to receive at least one recovery panels. In one embodiment, each of the two or more rails define a channel into which respective edges of the at least one recovery panel are slidably received. In one embodiment, the at least one recovery panel defines a plurality of cutouts configured to serve as attachment points for gear stowage, as well as a traction surface for positioning underneath wheels of the vehicle to aid in vehicle recovery. In one embodiment, the plurality of cutouts form a Modular Lightweight Load-carrying Equipment pattern.

In one embodiment, the system further includes at least one horizontally oriented support operably coupled to the at least one modular column configured to provide rigidity and support to at least one of a storage shelf, work surface or bed platform. In one embodiment, the at least one horizontally oriented support is operably coupled to the at least one modular column along at least two surfaces of the at least one modular column. In one embodiment, the system further includes a plurality of horizontally oriented supports configured to form a multilevel structure representing at least one shelf and a portion of a bed platform.

In one embodiment, the system further includes at least two modular columns and at least two horizontally oriented supports, the at least two horizontally oriented supports configured to provide rigidity and support to a bed platform. In one embodiment, the bed platform comprises a first panel, a second panel and a third panel. In one embodiment, the second panel is operably coupled to the third panel by a hinge enabling the second panel to pivot between a substantially horizontal use orientation and a substantially vertical storage position. In one embodiment, in the storage position, the second panel, third panel and an interior wall of the vehicle cooperate to form a storage compartment.

In one embodiment, the system further includes a deck assembly including a substantially rigid, planar deck plate pivotably coupleable to a rear of the vehicle inside of the one or more rear doors by a hinge assembly, wherein the deck plate is configured pivotably transition between a substantially horizontally orientated use position extending beyond the one or more rear doors to an exterior of the vehicle, and a substantially vertical oriented storage position inside of the one or more rear doors, wherein in the use position, the deck plate is supported by one or more tension members traversing from the deck plate to at least one of a rear portion of the vehicle or the at least one modular column above the deck plate. In one embodiment, one or more tension members are in the form of at least one of length adjustable straps. In one embodiment, the hinge assembly comprises a single hinge traversing a width of the deck plate. In one embodiment, the deck plate is configured to support a weight of at least 500 pounds in the use position. In one embodiment, the system further includes a include a gas charged support strut configured to slow a rate of descent of the deck plate as it transitions from the storage position to the use position, and ease in lifting or retraction of the deck plate as it transitions from the use position to the storage position.

In one embodiment, deck plate defines a plurality of cutouts or perforations forming a pattern configured to at least one of increase traction, enable ease in drainage, or serve as a connection point for gear operably coupled to a bottom surface of the deck plate. In one embodiment, the deck assembly is configured to form a low-profile storage compartment between an interior of the one or more rear doors and a bottom surface of the deck plate, when the deck plate is in the storage position.

In one embodiment, the system further includes a step extendable below the bottom surface of the deck plate. In one embodiment, the step is configured to naturally pivot under a force of gravity from a storage position to an extended, use position as the deck plate transitions from the storage position to the use position.

In one embodiment, the system further includes one or more walls configured to be erected around at least a perimeter of the deck plate. In one embodiment, the one or more walls are constructed of a durable fabric material configured to be easily stored when not in use.

A system or method according to any embodiment, wherein the deck plate defines one or more post connections configured to receive one or more wall posts. In one embodiment, the one or more wall posts are configured to telescope in length, so as to extend to height substantially equal with a roof of the vehicle. In one embodiment, the system further includes one or more flexible rods configured to be operably coupled between the one or more wall posts and a rear portion of the vehicle. In one embodiment, the one or more flexible rods include a Y-junction. In one embodiment, the system further includes a fabric enclosure configured to be operably coupleable to the wall posts and one or more flexible rods to form a partial enclosure of the deck assembly. In one embodiment, the partial enclosure includes both an opaque layer and a mosquito netting layer, with one or more zippers to selectively open or establish various configurations of the partial enclosure.

In one embodiment, the system further includes an x-tray panel configured to slide and pivot relative to the deck plate. In one embodiment, the deck plate defines a rail along which the x-tray panel is configured to slide. In one embodiment, the x-tray panel is configured at least one of slide or pivot to be at least partially in contact with a floor of the vehicle. In one embodiment, the x-tray panel is configured at least one of slide or pivot to form a ramp between a ground surface and the deck plate.

In one embodiment, the invention comprises a vehicle comprising the modular vehicle system according to any embodiment of the disclosure.

The summary above is not intended to describe each illustrated embodiment or every implementation of the present disclosure. The figures and the detailed description that follow more particularly exemplify these embodiments.

### BRIEF DESCRIPTION OF THE DRAWINGS

The disclosure can be more completely understood in consideration of the following detailed description of various embodiments of the disclosure, in connection with the accompanying drawings, in which:

FIG. 1 is a perspective view depicting a modular vehicle system including a deck assembly configured in the use position, in accordance with an embodiment of the disclosure.

FIG. 2 is a perspective view depicting a modular vehicle system of FIG. 1, with the deck assembly configured in the storage position, in accordance with an embodiment of the disclosure.

FIG. 3 is a close-up perspective view depicting tension members of a modular vehicle system deck assembly, in accordance with an embodiment of the disclosure.

FIG. 4 is a perspective view depicting a modular vehicle system deck assembly including a partial enclosure, in accordance with an embodiment of the disclosure.

FIG. 5 is a perspective view depicting a modular vehicle system including a modular column, in accordance with an embodiment of the disclosure.

FIG. 6 is a perspective view depicting a modular column including an optional table mount and entertainment system mount, in accordance with an embodiment of the disclosure.

FIG. 7 is a perspective view depicting a modular column comprised of an extruded first and second component configured to slide relative to one another for adjustment in an overall length of the modular column, in accordance with an embodiment of the disclosure.

FIG. 8 is a close-up perspective view depicting a modular vehicle system deck assembly including a support strut, in accordance with an embodiment of the disclosure.

FIG. 9 is a close-up perspective view depicting a modular vehicle system deck assembly including a locking member configured to security vehicle deck system in a storage position, in accordance with an embodiment of the disclosure.

FIG. 10 is a close-up perspective view depicting a modular column including a tab configured to interact with the locking member depicted in FIG. 9, in accordance with an embodiment of the disclosure.

FIG. 11 is a perspective view depicting a modular vehicle system including one or more horizontal supports configured to support at least one of a shelf, horizontal work platform or bed platform, in accordance with an embodiment of the disclosure.

FIG. 12 is a close-up perspective view depicting the coupling between the one or more horizontal supports and the modular column of FIG. 11, in accordance with an embodiment of the disclosure.

FIG. 13 is a perspective view depicting a modular vehicle system including one or more horizontal rails configured to receive one or more recovery panels, in accordance with an embodiment of the disclosure.

FIG. 14 is a close-up perspective view depicting the one or more horizontal rails of FIG. 13, in accordance with an embodiment of the disclosure.

FIG. 15 is a perspective view depicting the modular vehicle system of FIG. 13, with the one or more recovery panels in a vertical, storage position, in accordance with an embodiment of the disclosure.

FIG. 16 is a perspective view depicting modular vehicle system including one or more horizontally oriented shelves or panels, in accordance with an embodiment of the disclosure.

FIG. 17 is an exploded perspective view depicting a modular vehicle system including a three component bed platform, in accordance with an embodiment of the disclosure.

FIG. 18 is a perspective view depicting the modular vehicle system of claim 17, in which the bed platform is in a storage position, in accordance with an embodiment of the disclosure.

FIG. 19 is a perspective view depicting a modular vehicle system including an x-tray slidably coupled to a deck assembly, in accordance with an embodiment of the disclosure.

FIG. 20 is a perspective view depicting the modular vehicle system of FIG. 19, with the x-tray transitioned into a portion of a vehicle, in accordance with an embodiment of the disclosure.

FIG. 21 is a close-up perspective view of a hinge and slider assembly of the modular vehicle system of FIG. 20, in accordance with an embodiment of the disclosure.

FIG. 22 is a perspective view depicting the modular vehicle system of FIG. 19, with the x-tray transitioned into a ramp extending from the deck assembly, in accordance with an embodiment of the disclosure.

FIG. 23 is a close-up perspective view depicting hinge and slider assembly of the modular vehicle system of FIG. 22, in accordance with an embodiment of the disclosure.

While embodiments of the disclosure are amenable to various modifications and alternative forms, specifics thereof shown by way of example in the drawings will be described in detail. It should be understood, however, that the intention is not to limit the disclosure to the particular embodiments described. On the contrary, the intention is to cover all modifications, equivalents, and alternatives falling within the spirit and scope of the subject matter as defined by the claims.

### DETAILED DESCRIPTION

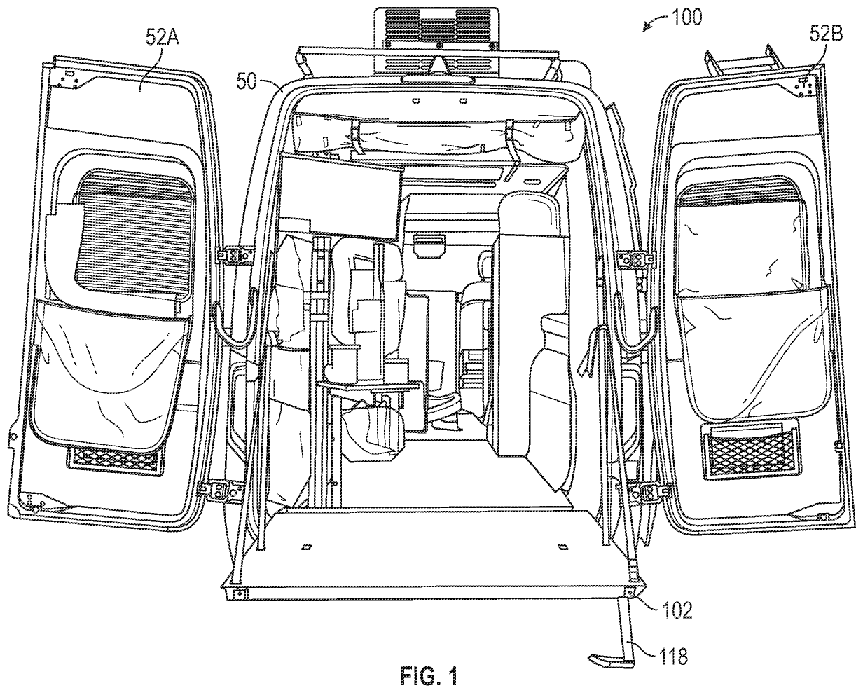

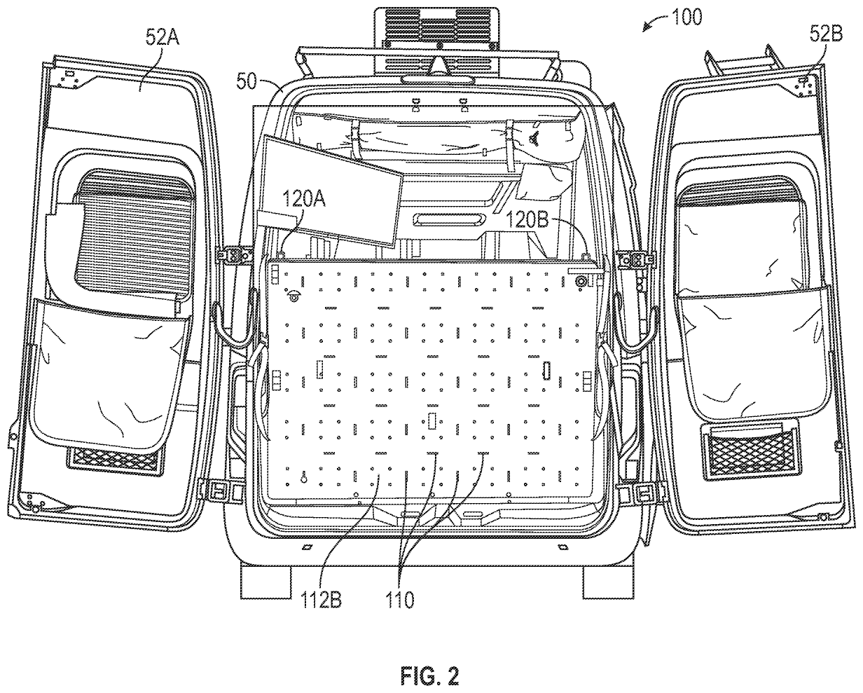

Referring to FIGS. 1-2, a modular vehicle system 100 is depicted in accordance with an embodiment of the disclosure. In embodiments, the modular vehicle system 100 can include a deck assembly configured to hingedly couple to a rear portion of a vehicle 50, inside of the rear doors 52A-B, such that the modular vehicle system 100 is configured to transition between a substantially horizontal use position (as depicted in FIG. 1), and a substantially vertical storage position (as depicted in FIG. 2). Although the rear doors 52A-B are depicted as a style of door commonly referred to as barn doors, use of the modular vehicle system 100 with other rear doors, including but not limited to garage or tailgate style doors are also contemplated. When parked, the deck assembly of the modular vehicle system 100 can quickly multiply the livable floor space of the vehicle. For example, in some embodiments, the deck assembly of the modular vehicle system 100 can add about twenty-five square feet of additional floor space, with a weight capacity in excess of 500 pounds. In other embodiments, the dimensions and weight limits of the modular vehicle system 100 can vary.

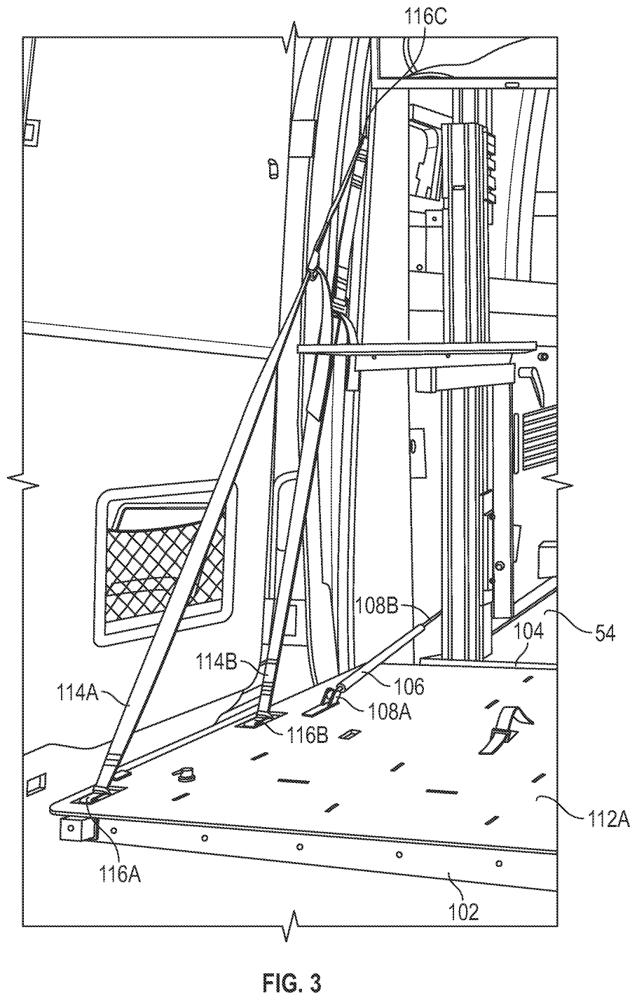

With additional reference to FIG. 3, the deck assembly can include a deck plate 102 pivotably coupled to a rear portion of the vehicle 50, such that a top surface 112A of the deck plate 102 is substantially flush with an interior floor 54 of the vehicle 50, thereby creating a smooth transition between the interior floor 54 and the deck plate 102, with no step up or step down between the interior floor 54 and the deck plate 102. For example, in some embodiments, the deck plate 102 can be mounted to the vehicle 50 via a hinge 104 (e.g., single ball bearing hinge, but hinge, offset hinge or the like), traversing the width of the deck plate 102. The use of multiple hinges (e.g., a knife hinges opposing ends of the deck plate 102, etc.) is also contemplated.

The deck plate 102 can be constructed of any rigid or semi-rigid material, particularly those with a strength-to-weight ratio enabling the deck plate 102 to support weights in excess of 500 pounds, without requiring a significant amount of lifting effort to transition the deck plate 102 between the use position and the storage position. To aid in transitioning the deck plate 102 between the use position and the storage position (and vice versa), in some embodiments, the modular vehicle deck extension can include a gas charged support strut 106 coupled between a first strut coupling 108A located on the deck plate 102, and a second strut coupling 108B located above the top surface 112A of the deck plate 102 on an opposite side of the hinge 104 than the first strut coupling 108A. Accordingly, in embodiments, the support strut 106 can serve to slow the rate of descent of the deck plate 102 as it transitions from the storage position to the use position, and ease in lifting or retraction of the deck plate 102 as it transitions from the use position to the storage position.

The deck plate 102 can include a plurality of cutouts 110 or perforations, which in some embodiments can form a pattern. In embodiments, the cutouts 110 can be multi-purposed; for example, the cutouts 110 can increase traction (as opposed to a smooth surface), enable ease in drainage, and serve as a connection point for gear operably coupled to a bottom surface 112B of the deck plate 102. For example, a snowboard, skis, or other generally flat item can be secured to the bottom surface 112B, so as to be readily accessible when the vehicle doors 52A-B are open and the deck plate 102 is in the storage position, while safely remaining within the confines of the interior of the vehicle when the doors 52A-B are closed. Moreover, when the deck plate 102 is in the storage position, the modular vehicle system 100 forms a low-profile storage compartment (also referred to herein as a “vault”) between an interior of the doors 52A-B and a bottom surface 112B of the deck plate 102, such that only the top surface 112A of the deck plate 102 is visible within the vehicle.

With continued reference to FIG. 3, one or more tension members 114A-B can be configured to provide stability to the deck plate 102 in the use position. For example, in some embodiments, the tension members 114A-B can be in the form of straps or cables, which can be adjustable in length to create a custom leveling of the deck plate 102 relative to the interior floor 54 or gravitational frame of reference. In some embodiments, each tension member 114 can be configured to withstand a tensile force between a first tension member coupling 116A, for example located on the deck plate 102, and a second tension member coupling 116C located on a rear portion of the vehicle 50 above the deck plate 102. In some embodiments, the tensioning members 114A-B can each have their own first tension member coupling 116A, 116B, while sharing a second tension member coupling 116C; although other tension member coupling configurations are also contemplated.

As depicted in FIG. 1, in some embodiments, the modular vehicle system 100 can optionally include a step 118, which can be operably coupled to the deck plate 102. For example, in one embodiment, the step 118 can be pivotably coupled to the deck plate 102, such that the step 118 naturally pivots or transitions from a storage position to an extended, use position as the deck plate 102 transitions from the storage position to the use position.

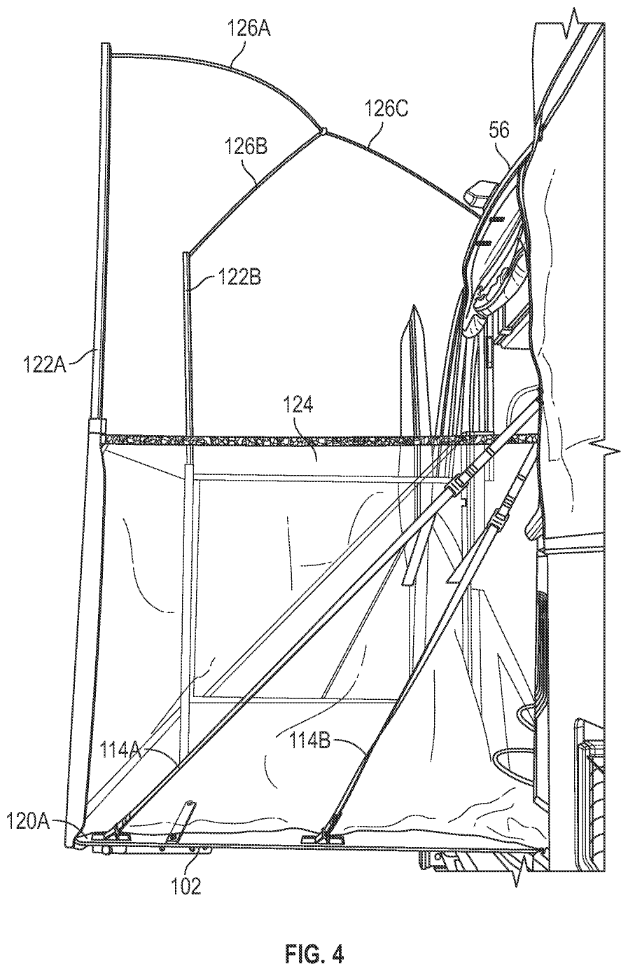

With additional reference to FIG. 4, in some embodiments, an enclosure or partial enclosure can optionally be erected around the deck assembly of the modular vehicle system 100. For example, in some embodiments, the deck plate 102 can define one or more post connections 120A-B (also depicted in FIG. 2), configured to receive a wall post 122A-B. For example, in some embodiments, the one or more post connections 120A-B can define a square, circular or other shaped cutout configured to receive a correspondingly shaped wall posts 122A-B. Thereafter, one or more walls 124 can be operably coupled to the wall posts 122A-B and vehicle 50, thereby forming a partial enclosure of the modular vehicle system 100. For example, in some embodiments, the walls 124 can be constructed of a durable fabric material configured to be easily stored when not in use.

In some embodiments, the wall posts 122A-B can telescope in length, for example, so as to extend to a height substantially equal with a roof 56 of the vehicle 50. To support a ceiling enclosure, in some embodiments one or more flexible rods 126A-C can be configured to operably couple the wall posts 122A-B to a rear portion of the vehicle 50. For example, in some embodiments, the flexible rods 126A-C can be in the form of flexible fiberglass or aluminum rods with a Y-junction 128 configured form a Y-configuration having sufficient strength to support a ceiling of the enclosure. In such an embodiment, the walls 124 and optional ceiling of the enclosure can operably couple to the wall posts 122A-B, rods 126A-C and vehicle 50 with fasteners (e.g., hook and loop fastener, etc.). In some embodiments, the walls 124 can be in the form of a mosquito net. In other embodiments, the walls 124 can include both an opaque layer (e.g., for privacy, protection from the elements, etc.) and a netting layer, along with one or more zippers to selectively open or establish various configurations of the walls 124. In other embodiments, the modular vehicle system 100 can include one or more panels hingedly coupled to the deck plate 102, which can be selectively pivoted from a storage position to a substantially vertical in use, wall position when desired.

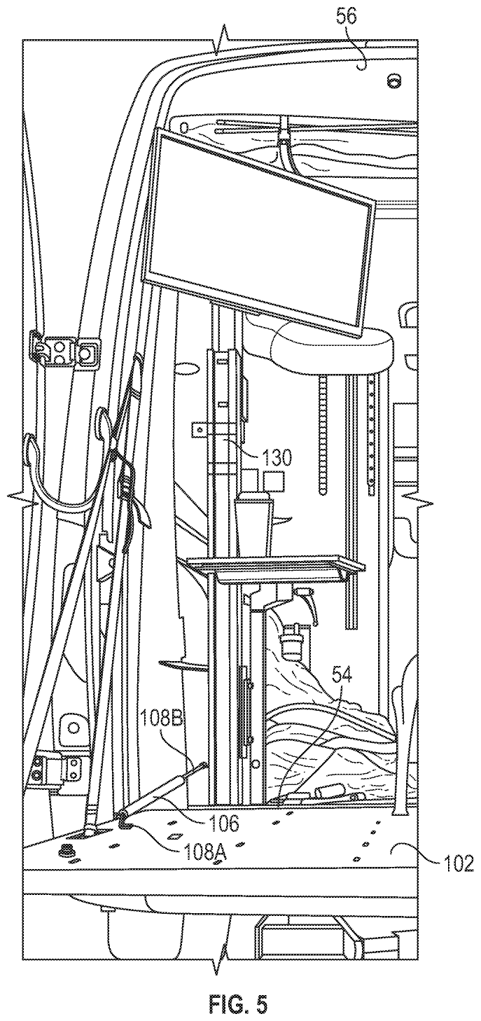

With reference to FIG. 5, in some embodiments, the modular vehicle system 100 can include one or more modular columns 130 configured to serve as a support member to various other portions of the modular vehicle system 100 (e.g., the deck plate 102 in the storage position, shelving, bed, etc.), as well as to provide a vertical surface for the mounting of a table, entertainment system, portable shower, etc. in proximity to a rear of the vehicle. In embodiments, the one or more modular columns can present a structural element having a variety of shapes and surfaces from which to build on. The one or more modular columns 130 can include an integrated rear utility station, constructed of a variety of materials, including extruded aluminum, wood, etc, configured to serve as an attachment point for multiple accessories, including but not limited to, a vertically slidable Lagun table, a TV mount, a wet bar, clothes hanging, a couch mounted between the modular column integrated rear utility station and the back wall of the bathroom with built in storage for hard mounted battery pack expansion kits and other secure compartments, and for securing the deck plate 102 in the storage position for travel. Further, the one or more modular columns 130 can be configured to use the existing vehicle chassis structural door opening with existing manufacturer attachment points, thereby enabling current model, prior year and future model use compatability.

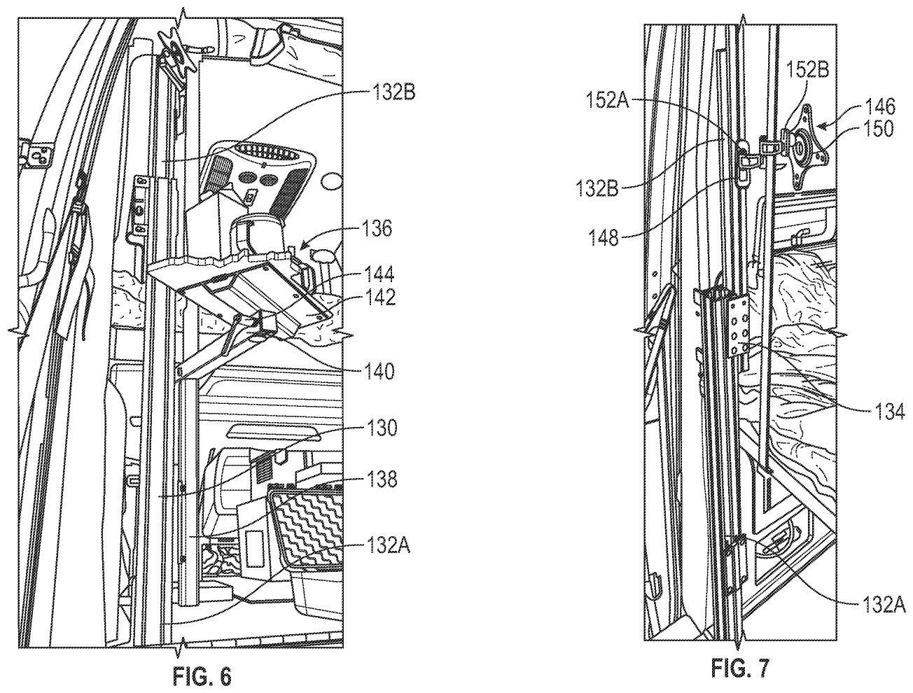

With additional reference to FIGS. 6-7, in some embodiments, the one or more columns 130 can be adapted to mount to the vehicle floor 54 and ceiling 56 inside of the rear doors 52A-B, so as to span a full height of the interior of the vehicle. For example, in some embodiments, the one or more columns 130 can be configured to span a distance of at least 75 inches. In some embodiments, the one or more columns 130 can be adjustable in height, for example telescoping or otherwise having at least a first component 132A and a second component 132B slidable relative to one another. For example, in some embodiments, the first and second components 132A/B can be constructed of and extruded aluminum or other material, wherein a protrusion defined on an exterior of the first component 132A is configured to be slidably received within a channel defined in an exterior of the second component 132B, thereby restricting movement of the first and second components 132A/B to only an adjustment of an overall length of the column 130. In some embodiments, the first and second components 132A/B can be locked in position relative to one another via a locking member 134.

As depicted in FIGS. 5 and 6, in some embodiments, an optional table mount 136 can be operably coupled to the one or more columns 130. In embodiments, the table mount 136 can include a substantially vertical member 138 operably coupleable to the column 130, a substantially horizontal member 140 pivotably coupled to the substantially vertical member 138, and a table support 142 pivotably coupled to the substantially horizontal member 140. Accordingly, in use, the optional table mount 136 can be used inside of the vehicle 50 (e.g., when the rear doors 52A-B are closed), and selectively pivoted to an outside of the vehicle 50 (e.g., when the rear doors 52A-B are open, and the deck plate 102 is in the use positioned). In some embodiments, one or more pivot locks 144 can be employed to lock the optional table mount 136 in a desired position.

As depicted in FIGS. 6 and 7, in some embodiments, an optional entertainment system mount 146 can be operably coupled to the one or more columns 130. In embodiments, the entertainment system mount 146 can include a column connecting member 148 configured to be mounted to the one or more columns 130, and entertainment system connecting member 150 configured to be operably coupled to a monitor, television, or other device, and one or more linkages 152A-B configured to enable adjustment in positioning of the entertainment system connecting member 150 relative to the column connecting member 148.

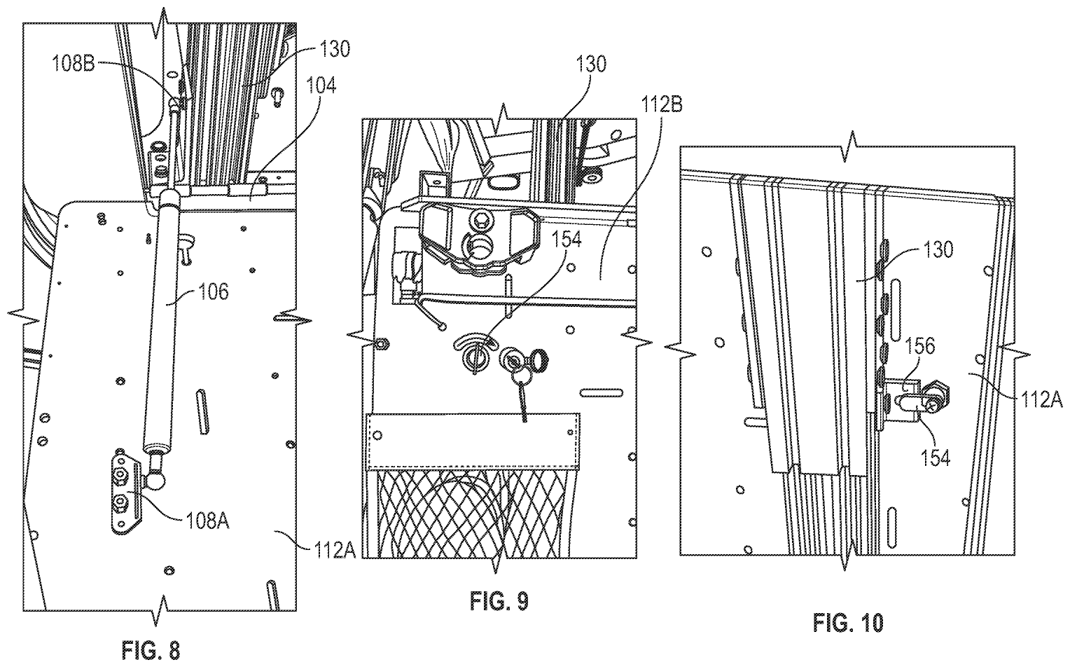

With additional reference to FIGS. 8 and 9A-B, in some embodiments, the one or more columns 130 can be configured to serve as a support member to the deck plate 102. For example, as depicted in FIG. 8, in some embodiments, the column 130 can serve as an anchor point for the support strut coupling 108B, thereby supporting one and of the support strut 106, with the other end of the support strut 106 anchored to the support strut coupling 108A mounted to the deck plate 102. Further, as depicted in FIGS. 9A-B, in some embodiments, the deck plate 102 can include a locking member 154 configured to interface with a retention tab 156 coupled to the column 130, thereby enabling the deck plate 102 to be secured in the substantially vertical storage position against one surface of the column 130.

As depicted in FIG. 9, in some embodiments, the locking member 154 can be secured in a locked position with a key, fob, keypad, etc., such that when the deck plate is in the storage position, the modular vehicle system 100 forms a low-profile storage vault between interior of the doors 52A/B and a bottom surface 112B of the deck plate 102. Accordingly, if a potential thief were to gain access to an interior of the vehicle through one of the other doors or windows items secured within the vault (and by the vertical position of the vehicle deck 102 generally) would be inaccessible. Thus, embodiments of the present disclosure both reduce the need for an external storage system and provide additional peace of mind, as gear is stored not just in the vehicle, but within a secure vault inside of the vehicle.

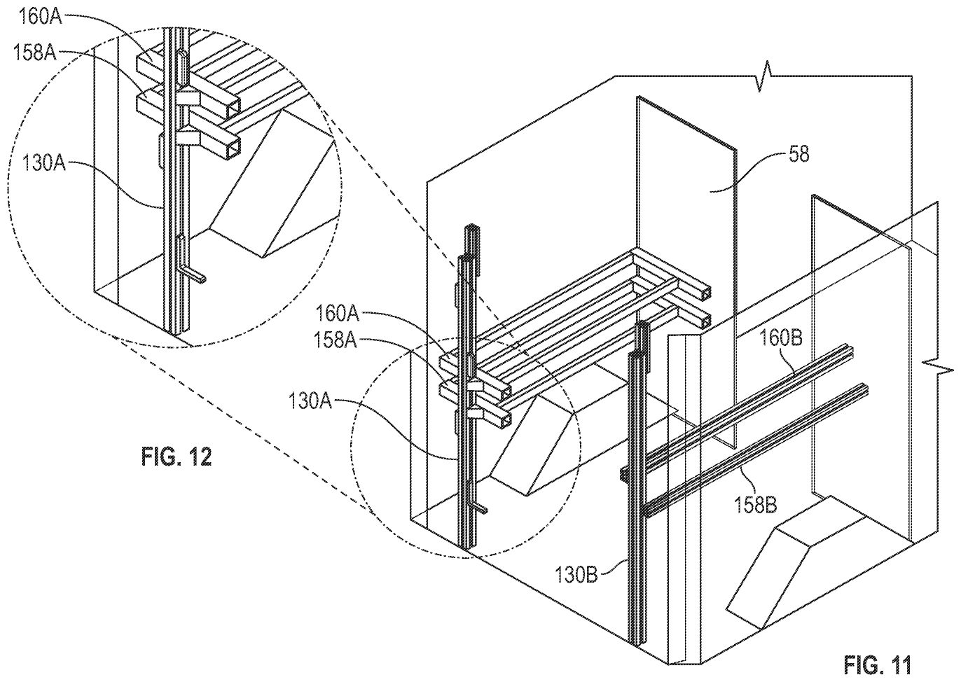

With additional reference to FIG. 11, in some embodiments, one or more substantially horizontally oriented supports 158A-B, 160A-B can be operably coupled between the modular columns 130A-B and an interior supporting surface 58 of the vehicle 50. In embodiments, the supports 158A-B, 160A-B can be configured to provide rigidity and support to generally horizontally oriented surfaces, including, but not limited to, a storage shelf, work surface/table, bed platform, and the like. As depicted, supports 158A-B, 160A-B can optionally be configured to form a multi-level structure, thereby creating a series of shelves/horizontal surfaces for increased storage and improved usability.

As depicted in FIG. 11, in some embodiments, the supports 158B, 160B can be in the form of a rigid beam, for example constructed out of an extruded metal (e.g., aluminum alloy) or other material configured to span a distance between the column 130B and the interior vehicle supporting surface 58. Alternatively, as also depicted in FIG. 11, the supports 158A, 160A can be in the form of a frame including multiple rigid beams configured to span a distance between the column 130B and the interior vehicle supporting surface 58. For increased stability in some embodiments, the multiple rigid beams can be supported at their respective ends by end members. With additional reference to FIG. 12, in some embodiments, for improved stability, the supports 158A, 160A can be configured to contact the column 130A along at least two surfaces.

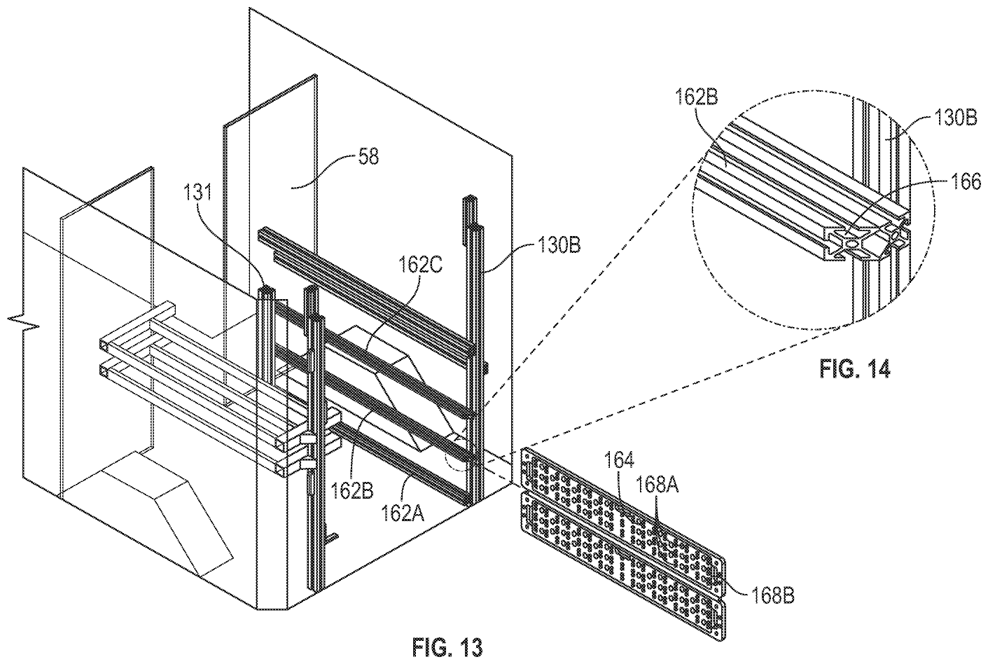

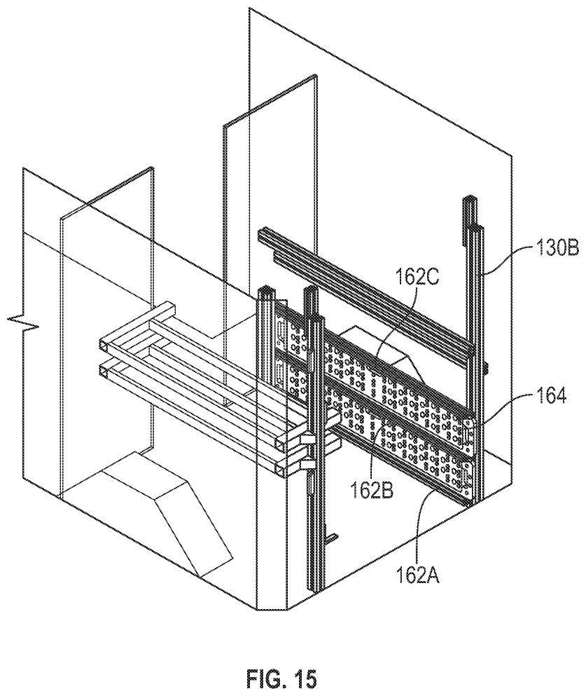

With additional reference to FIG. 13, in some embodiments, one or more tracks or rails 162A-C can be operably coupled between a modular column 130B and an interior vehicle surface 58. In some embodiments, a secondary column 131 can be used to aid in coupling the one or more tracks 162A-C to the supporting surface 58. The one or more tracks 162A-C can be configured to receive one or more generally vertically oriented panels 164A-B. For example, with additional reference to FIG. 14, in one embodiment, the tracks 162A-C can be constructed of an extruded metal (e.g., aluminum alloy) or other material, defining a channel 166 into which an edge of a panel 164 can be slidably received for storage (as depicted in FIG. 15). With the rear vehicle doors open, the panels 164A-B can be slidably removed from the one or more tracks 162A-C (as depicted in FIG. 13).

In some embodiments, the panels 164A-B can be a compact form factor measuring about 1 inch thick, greater than 50 inches long and about less than about 12 inches wide; although other dimensions of the panel are also contemplated. The panels 164A-B can define one or more cutouts 168A-B or perforations, which can serve as attachment points for gear, straps, and other equipment, as well as a traction surface to be positioned between the ground and wheels of the vehicle to aid in vehicle recovery. In some embodiments, cutouts 168A can form a Modular Lightweight Load-carrying Equipment (MOLLE) pattern. Some of the cutouts 168B can have a dual function as a handgrip for use in manipulation of the panel when used as a vehicle recovery board; for example, in some embodiments, the panel can define three large handgrip apertures 168B positioned along a periphery of the panel 164. To aid in traction when used as a recovery board, in some embodiments, the panel 164 can further include a plurality of grip extensions protruding from a planar surface of the panel 164 configured to provide texture to reduce slipping when in contact with a tire.

In operation, gear and other accessories can be selectively coupled to a wall mounted panel 164A-B, as the panel 164A-B is held in place by the two or more slot rails 162A-C which are attached to the modular column 130B and a back of the passenger side utility closet wall 56. Gear can be coupled to the panels 164A-B for storage. In the event that the vehicle 50 becomes stuck, the gear and other accessories can be uncoupled from the panel 164A-B and the one or more panels 164A-B can be removed from the rails 162A-C for use as vehicle recovery boards, which can be positioned under the wheels of the vehicle to provide traction for a quicker and easier recovery.

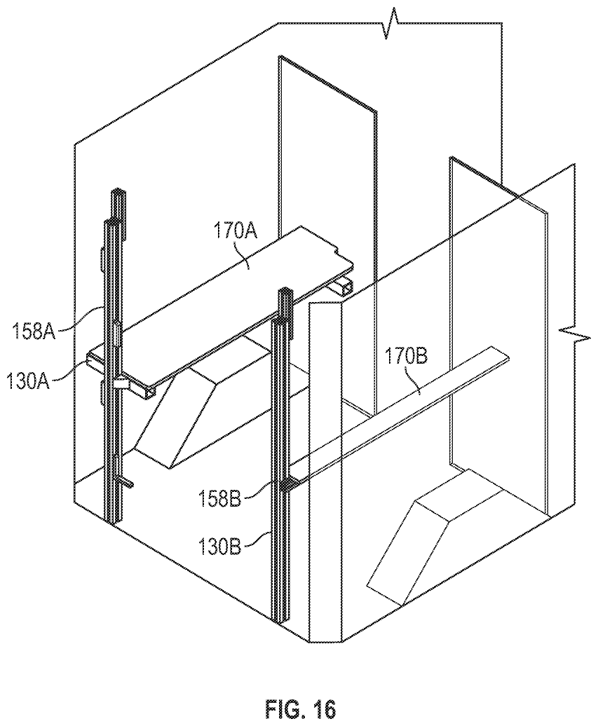

With reference to FIG. 16, in some embodiments, substantially horizontally oriented shelf panels 170A-B can be operably coupled to supports 158A-B, thereby forming shelves or horizontal work surfaces within the interior of the vehicle. In some embodiments, the substantially horizontally oriented shelf panels 170A-B can be configured as a storage rack for longer items (e.g., skis, snowboards, etc.), which can be stored crosswise across a width of the vehicle with a first end of the item resting on panel 170A and a second end of the item resting on panel 170B. In some embodiments, one or more shelves are platforms positioned above the substantially horizontally oriented shelf panels 170A-B can be used to establish a secure storage rack for longer items, particularly when used in combination with the locking member 154 with the modular vehicle system in the storage vault configuration, as in some cases removal of the longer items from the substantially horizontally oriented shelf panels 170A-B may only be accomplished through the rear doors 52A-B of the vehicle 50.

In some embodiments, an optional step 172 can be attached to a column 130A to aid in accessing higher, harder to reach areas within the interior of the vehicle. In some embodiments, the step 172 can be configured to fold between a storage position in which the step 172 in a substantially vertical, low-profile configuration relative to the column 130A, and a use position in which the step 172 is any substantially horizontal position orthogonal to a longitudinal axis of the column 130A.

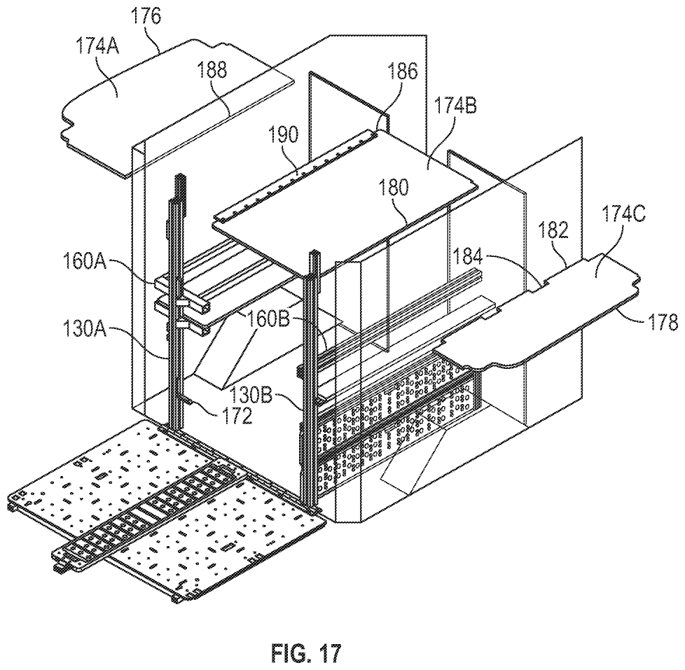

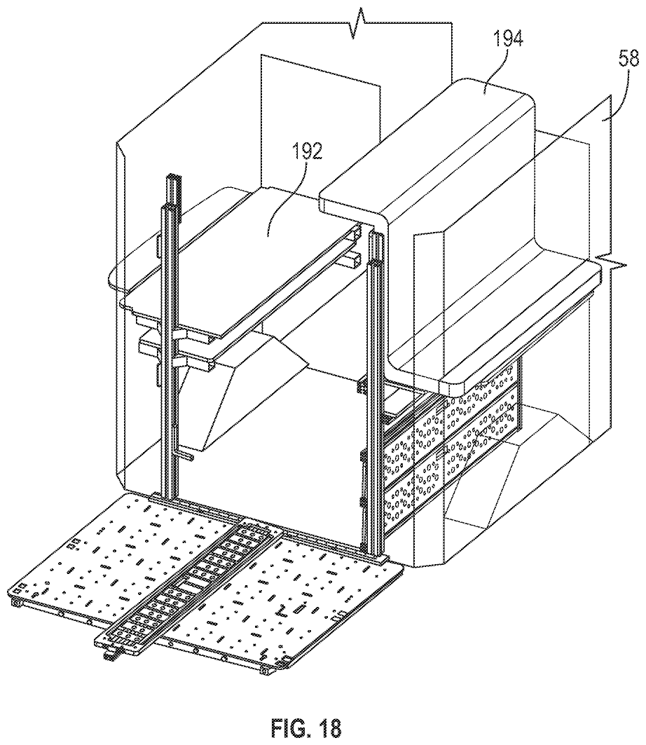

With reference to FIGS. 17-18, a plurality of substantially horizontally oriented bed panels 174A-C can be operably coupled to supports 160A-B, thereby forming a bed platform upon which a mattress or other bedding can be positioned. In some embodiments, the plurality of bed panels 174A-C can include a first panel 174A having a first, outer edge 176 contoured to an interior wall of the vehicle, thereby minimizing any gap between the first panel 174A and the partially surrounding interior wall of the vehicle. Similarly, a first, outer edge 178 of a third panel 174C can be contoured to an interior wall of the vehicle, thereby minimizing any gap between the third panel 174C and the partially surrounding interior wall of the vehicle.

A second panel 174B can be selectively positioned between the first panel 174A and the third panel 174C. In some embodiments, the second panel 174B can be hingedly coupled to either of the first or third panels 174A/C. For example, as depicted in FIG. 17, a first edge 180 of the second panel 174B can be coupled to a second edge 182 of the third panel 174C via a hinge mechanism 184. When the second panel 174B is positioned between the and second panels 174A/C, a second edge 186 of the second panel 174B can be configured to make abutting contact with a second edge 188 of the first panel 174A. In some embodiments, a plate 190 can be affixed to a top surface 192 of the second panel 174B to aid in maintaining the second panel 174B in a substantially horizontal orientation when a load is applied to the top surface 192. Thereafter, a mattress 194 or other bedding can be positioned at the top of the combined panels 174A-C.

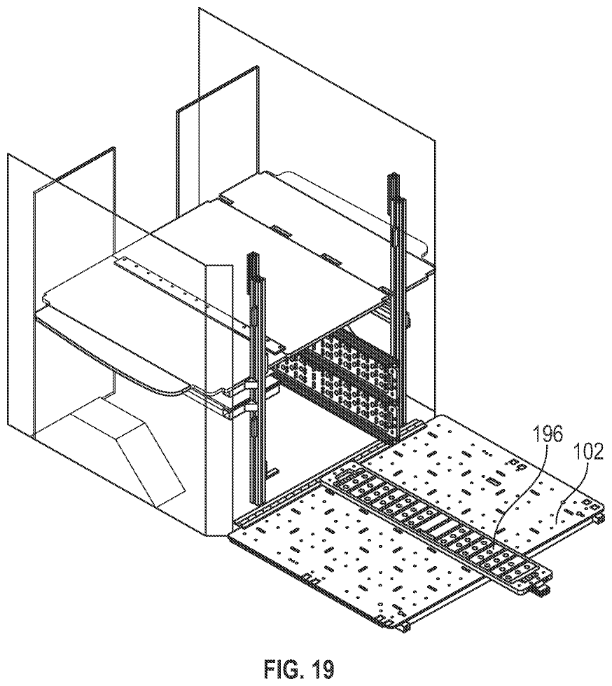

In some embodiments, the second panel 174B is configured to transition between a storage position (as depicted in FIG. 18) and an in use position (as depicted in FIG. 19). In the storage position, the second panel 174B is pivoted to a substantially vertical orientation, such that the mattress 194 bends the form a Z-shaped configuration, with other bedding (blankets, pillows, etc.) secured in a compartment defined between the mattress 194 and an interior wall of the vehicle, thereby enabling a user to use the first panel 174A as a table or work surface. Accordingly, the unique configuration of the second panel 174B enables the use of a single (body length) mattress, whereas the most similar beds of the prior art use a plurality of cushions to create a full-length body mattress. Additionally, by customizing a width of the second panel 174B (e.g., between the first edge 180 and the second edge 186) the bed platform can be tailored to the specific height and width of the vehicle. In some embodiments, the modular vehicle system 100 can include a multi-leveled bed platform assembly (e.g., bunkbed).

With reference to FIG. 19-23, in some embodiments, a substantially horizontally oriented panel 196 (alternatively referred to as an “X-tray”) can be configured to slide along at least a portion of the vehicle floor 56 and the deck plate 102, thereby enabling ease in storage and access to heavier items stored beneath the bed platform. For example, as depicted in FIG. 19, a rail or track 198 can be operably coupled to a top surface 112A of the deck plate 102, with one or more sliders 202 operably received within a channel defined by the track 198. In one embodiment, a bike (e.g., a front fork of a bike, etc.) can be secured to the X-tray 196, to be wheeled in and out of the vehicle as the X-tray 196 slides along the track 198, regardless of the configuration of the bed panels 174A-C. Accordingly, in some embodiments, the X-tray 196, in combination with other components of the modular vehicle system 100 (e.g., locking member 154, etc.) can be used for secure bike storage, particularly with the modular vehicle system 100 in the storage vault configuration as removal of the bike to any vehicle door other than the rear doors 52A-B would be extremely difficult.

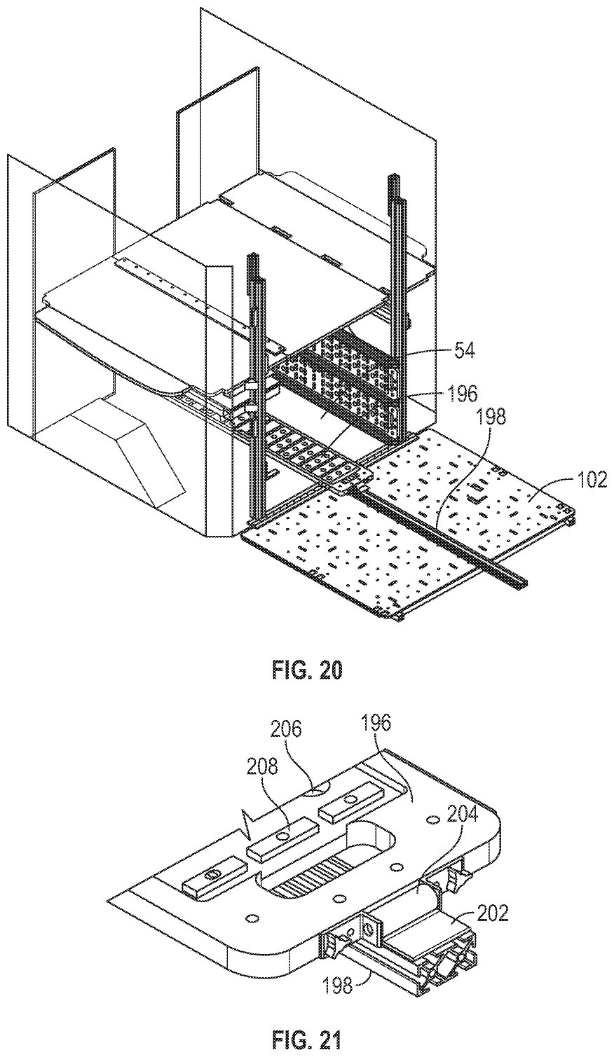

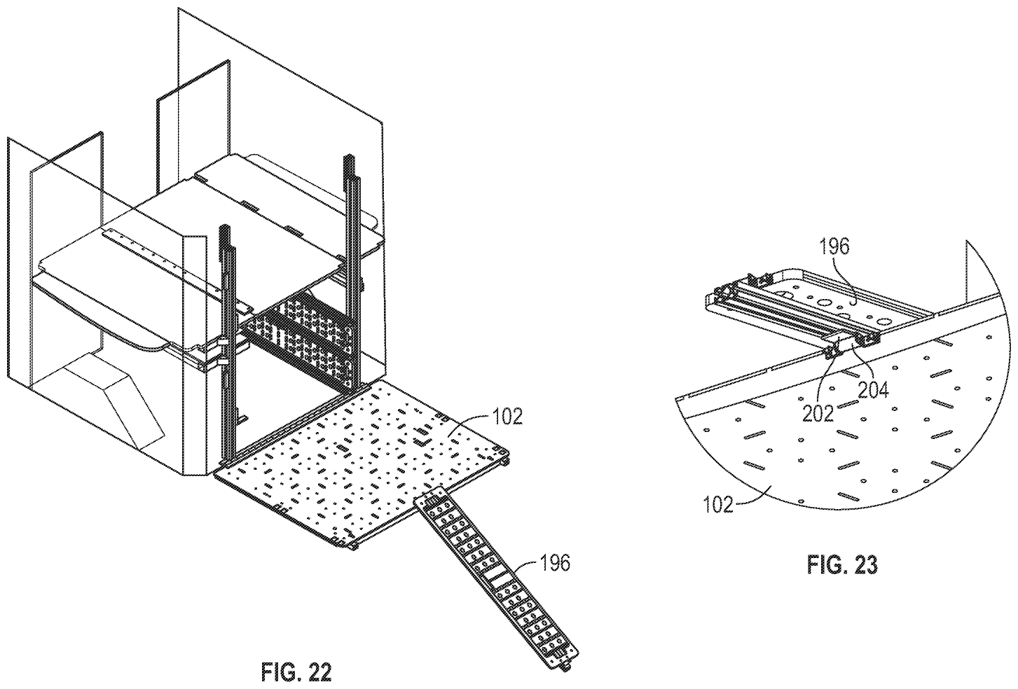

In some embodiments, the track 198 can be embedded into the surface of the deck plate 102 to reduce a likelihood of the track 198 presenting a trip hazard. As depicted in FIG. 21, a hinge 204 can operably couple the one or more sliders 202 to the panel 196, thereby enabling the panel 196 to pivot up to about 270° relative to the track 198 between an inverted substantially horizontal position (as depicted in FIG. 20) and a substantially vertical position (beyond that depicted in FIG. 22).

Accordingly, when not in use, the panel 196 can be stored flat, adjacent to the top surface 112A of the deck plate (as depicted in FIG. 19), such that the panel 196 is positioned in a substantially vertical orientation when the deck plate 102 is transitioned to the storage position. Alternatively, the panel 196 can either slide inwardly to be positioned adjacent to a floor 56 of the vehicle 50, or be flipped lengthwise about the hinge 204 to be inverted for storage adjacent to a floor 56 of the vehicle 50 (as depicted in FIG. 20). As depicted in FIG. 23, in some embodiments, the hinge 204 can be configured to securely couple the panel 196 to the deck plate 102, thereby enabling the panel 196 to serve as a ground engaging ramp up to the suspended, substantially horizontally oriented deck plate 102 (as depicted in FIG. 22).

Similar to the MOLLE boards, the X-tray 196 can define one or more cutouts 206 or perforations, which can serve as attachment points for gear, straps, and other equipment, as well as a traction surface. To aid in traction, in some embodiments, the panel 196 can further include a plurality of grip extensions 208 protruding from a planar surface of the panel 196 configured to provide texture to reduce slippage.

The invention is further illustrated by the following embodiments:

A modular vehicle system configured to improve storage of a vehicle including one or more rear doors, the modular vehicle system comprising:

at least one modular column configured to provide a vertical surface for mounting various attachments thereto, the at least one column including a first component and a second component, wherein the first component and the second component are slidable relative to one another to span a distance between a floor of the vehicle and a ceiling of the vehicle inside of the one or more rear doors.

A modular vehicle system configured to expand a livable space of a vehicle including one or more rear doors, the modular vehicle system comprising:

a deck assembly including a substantially rigid, planar deck plate pivotably coupleable to a rear of the vehicle inside of the one or more rear doors by a hinge assembly, wherein the deck plate is configured pivotably transition between a substantially horizontally orientated use position extending beyond the one or more rear doors to an exterior of the vehicle, and a substantially vertical oriented storage position inside of the one or more rear doors, wherein in the use position, the deck plate is supported by one or more tension members traversing from the deck plate to a rear portion of the vehicle above the deck plate.

A modular vehicle system configured to improve storage and expand a livable space of a vehicle including one or more rear doors, the modular vehicle system comprising:

a pair of modular columns configured to provide vertical surfaces for mounting various attachments thereto, each of the modular columns including a first component and a second component, wherein the first component and the second component are slidable relative to one another to span a distance of at least 75 inches between a floor of the vehicle and a ceiling of the vehicle inside of the one or more rear doors; and

a deck assembly including a substantially rigid, planar deck plate pivotably coupleable to a rear of the vehicle inside of the one or more rear doors by a hinge assembly, wherein the deck plate is configured pivotably transition between a substantially horizontally orientated use position extending beyond the one or more rear doors to an exterior of the vehicle, and a substantially vertical oriented storage position inside of the one or more rear doors aft of the pair of modular columns, wherein in the use position, the deck plate is supported by one or more tension members traversing from the deck plate to at least one of a rear portion of the vehicle or the pair of modular columns above the deck plate.

A modular vehicle system configured to improve storage of a vehicle including one or more rear doors, the modular vehicle system comprising:

at least one modular column configured to provide a vertical surface for mounting various attachments thereto, the at least one column including a first component and a second component, wherein the first component and the second component are slidable relative to one another to span a distance between a floor of the vehicle and a ceiling of the vehicle inside of the one or more rear doors; and

two or more substantially horizontally orientated rails configured to receive at least one recovery panels.

A modular vehicle system configured to improve storage of a vehicle including one or more rear doors, the modular vehicle system comprising:

at least two modular columns configured to provide a vertical surface for mounting various attachments thereto, each modular column including a first component and a second component, wherein the first component and the second component are slidable relative to one another to span a distance between a floor of the vehicle and a ceiling of the vehicle inside of the one or more rear doors; and

at least two horizontally oriented supports, the at least two horizontally oriented supports configured to provide rigidity and support to a bed platform.

A system or method according to any embodiment, wherein the first component and the second component are both constructed of and extruded metal, wherein a protrusion defined on an exterior of the first component is configured to be slidably received within a channel defined on an exterior of the second component, thereby restricting movement of the first and second components to an adjustment of overall length of the at least one column.

A system or method according to any embodiment, wherein the first component and the second component are configured to be locked in position relative to one another by a locking member.

A system or method according to any embodiment, further comprising at least one of a table mount or entertainment mount operably coupleable to the at least one column.

A system or method according to any embodiment, further comprising two or more substantially horizontally orientated rails configured to receive at least one recovery panels.

A system or method according to any embodiment, wherein each of the two or more rails define a channel into which respective edges of the at least one recovery panel are slidably received.

A system or method according to any embodiment, wherein the at least one recovery panel defines a plurality of cutouts configured to serve as attachment points for gear stowage, as well as a traction surface for positioning underneath wheels of the vehicle to aid in vehicle recovery.

A system or method according to any embodiment, wherein the plurality of cutouts form a Modular Lightweight Load-carrying Equipment pattern.

A system or method according to any embodiment, further comprising at least one horizontally oriented support operably coupled to the at least one modular column configured to provide rigidity and support to at least one of a storage shelf, work surface or bed platform.

A system or method according to any embodiment, wherein the at least one horizontally oriented support is operably coupled to the at least one modular column along at least two surfaces of the at least one modular column.

A system or method according to any embodiment, comprising a plurality of horizontally oriented supports configured to form a multilevel structure representing at least one shelf and a portion of a bed platform.

A system or method according to any embodiment, comprising at least two modular columns and at least two horizontally oriented supports, the at least two horizontally oriented supports configured to provide rigidity and support to a bed platform.

A system or method according to any embodiment, wherein the bed platform comprises a first panel, a second panel and a third panel.

A system or method according to any embodiment, wherein the second panel is operably coupled to the third panel by a hinge enabling the second panel to pivot between a substantially horizontal use orientation and a substantially vertical storage position.

A system or method according to any embodiment, wherein in the storage position, the second panel, third panel and an interior wall of the vehicle cooperate to form a storage compartment.

A system or method according to any embodiment, further comprising a unitary, body length mattress cushion configured to be selectively folded when the second panel is pivoted to the substantially vertical storage position.

A system or method according to any embodiment, further comprising a deck assembly including a substantially rigid, planar deck plate pivotably coupleable to a rear of the vehicle inside of the one or more rear doors by a hinge assembly, wherein the deck plate is configured pivotably transition between a substantially horizontally orientated use position extending beyond the one or more rear doors to an exterior of the vehicle, and a substantially vertical oriented storage position inside of the one or more rear doors, wherein in the use position, the deck plate is supported by one or more tension members traversing from the deck plate to at least one of a rear portion of the vehicle or the at least one modular column above the deck plate.

A system or method according to any embodiment, wherein the one or more tension members are in the form of at least one of length adjustable straps.

A system or method according to any embodiment, wherein the hinge assembly comprises a single hinge traversing a width of the deck plate.

A system or method according to any embodiment, wherein the deck plate is configured to support a weight of at least 500 pounds in the use position.

A system or method according to any embodiment, further comprising a include a gas charged support strut configured to slow a rate of descent of the deck plate as it transitions from the storage position to the use position, and ease in lifting or retraction of the deck plate as it transitions from the use position to the storage position.

A system or method according to any embodiment, wherein the deck plate defines a plurality of cutouts or perforations forming a pattern configured to at least one of increase traction, enable ease in drainage, or serve as a connection point for gear operably coupled to a bottom surface of the deck plate.

A system or method according to any embodiment, wherein the deck assembly is configured to form a low-profile storage vault between an interior of the one or more rear doors and a bottom surface of the deck plate, when the deck plate is in the storage position.

A system or method according to any embodiment, further comprising a step extendable below the bottom surface of the deck plate.

A system or method according to any embodiment, wherein the step is configured to naturally pivot under a force of gravity from a storage position to an extended, use position as the deck plate transitions from the storage position to the use position.

A system or method according to any embodiment, further comprising one or more walls configured to be erected around at least a perimeter of the deck plate.

A system or method according to any embodiment, wherein the one or more walls are constructed of a durable fabric material configured to be easily stored when not in use.

A system or method according to any embodiment, wherein the deck plate defines one or more post connections configured to receive one or more wall posts.

A system or method according to any embodiment, wherein the one or more wall posts are configured to telescope in length, so as to extend to height substantially equal with a roof of the vehicle.

A system or method according to any embodiment, further comprising one or more flexible rods configured to be operably coupled between the one or more wall posts and a rear portion of the vehicle.

A system or method according to any embodiment, wherein the one or more flexible rods include a Y-junction.

A system or method according to any embodiment, further comprising a fabric enclosure configured to be operably coupleable to the wall posts and one or more flexible rods to form a partial enclosure of the deck assembly.

A system or method according to any embodiment, wherein the partial enclosure includes both an opaque layer and a mosquito netting layer, with one or more zippers to selectively open or establish various configurations of the partial enclosure.

A system or method according to any embodiment, further comprising an x-tray panel configured to slide and pivot relative to the deck plate.

A system or method according to any embodiment, wherein the deck plate defines a rail along which the x-tray panel is configured to slide.

A system or method according to any embodiment, wherein the x-tray panel is configured at least one of slide or pivot to be at least partially in contact with a floor of the vehicle.

A system or method according to any embodiment, wherein the x-tray panel is configured at least one of slide or pivot to form a ramp between a ground surface and the deck plate.

A vehicle comprising the modular vehicle system according to any embodiment of the disclosure.

Various embodiments of systems, devices, and methods have been described herein. These embodiments are given only by way of example and are not intended to limit the scope of the claimed inventions. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the claimed inventions.

Persons of ordinary skill in the relevant arts will recognize that the subject matter hereof may comprise fewer features than illustrated in any individual embodiment described above. The embodiments described herein are not meant to be an exhaustive presentation of the ways in which the various features of the subject matter hereof may be combined. Accordingly, the embodiments are not mutually exclusive combinations of features; rather, the various embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted.

Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of 35 U.S.C. § 112(f) are not to be invoked unless the specific terms “means for” or “step for” are recited in a claim.

What is claimed is:

1. A modular vehicle system configured to improve storage of a vehicle including one or more rear doors, the modular vehicle system comprising:
at least one modular column configured to provide a vertical surface for mounting various attachments thereto, the at least one column including a first component and a second component, wherein the first component and the second component are slidable relative to one another to span a distance between a floor of the vehicle and a ceiling of the vehicle inside of the one or more rear doors.

2. The modular vehicle system of claim 1, wherein the first component and the second component are both constructed of and extruded metal, wherein a protrusion defined on an exterior of the first component is configured to be slidably received within a channel defined on an exterior of the second component, thereby restricting movement of the first and second components to an adjustment of overall length of the at least one column.

3. The modular vehicle system of claim 1, further comprising at least one step operably coupleable to the at least one modular column.

4. The modular vehicle system of claim 1, wherein the steps configured to transition between a substantially vertical, low-profile storage position and a substantially horizontal use position, orthogonal to a longitudinal axis of the at least one modular column.

5. The modular vehicle system of claim 1, further comprising two or more substantially horizontally orientated rails configured to receive at least one recovery panels.

6. The modular vehicle system of claim 5, wherein each of the two or more rails define a channel into which respective edges of the at least one recovery panel are slidably received.

7. The modular vehicle system of claim 5, wherein the at least one recovery panel defines a plurality of cutouts configured to serve as attachment points for gear stowage, as well as a traction surface for positioning underneath wheels of the vehicle to aid in vehicle recovery.

8. The modular vehicle system of claim 1, comprising at least two modular columns and at least two horizontally oriented supports, the at least two horizontally oriented supports configured to provide rigidity and support to a bed platform.

9. The modular vehicle system of claim 8, wherein the bed platform comprises a first panel, a second panel and a third panel, wherein the second panel is operably coupled to the third panel by a hinge enabling the second panel to pivot between a substantially horizontal use orientation and a substantially vertical storage position.

10. The modular vehicle system of claim 9, wherein the storage position, the second panel, third panel and an interior wall of the vehicle cooperate to form a storage compartment.

11. The modular vehicle system of claim 10, further comprising a unitary, body length mattress cushion configured to be selectively folded when the second panel is pivoted to the substantially vertical storage position.

12. The modular vehicle system of claim 1, further comprising a deck assembly including a substantially rigid, planar deck plate pivotably coupleable to a rear of the vehicle inside of the one or more rear doors by a hinge assembly, wherein the deck plate is configured pivotably transition between a substantially horizontally orientated use position extending beyond the one or more rear doors to an exterior of the vehicle, and a substantially vertical oriented storage position inside of the one or more rear doors, wherein in the use position, the deck plate is supported by one or more tension members traversing from the deck plate to at least one of a rear portion of the vehicle or the at least one modular column above the deck plate.

13. The modular vehicle system of claim 12, wherein the one or more tension members are in the form of at least one of length adjustable straps.

14. The modular vehicle system of claim 12, wherein the deck plate defines a plurality of cutouts or perforations forming a pattern configured to at least one of increase traction, enable ease in drainage, or serve as a connection point for gear operably coupled to a bottom surface of the deck plate.

15. The modular vehicle system of claim 12, wherein the deck assembly is configured to form a secure storage vault within the vehicle between an interior of the one or more rear doors and a bottom surface of the deck plate, when the deck plate is in the storage position.

16. The modular vehicle system of claim 12, wherein the deck plate defines one or more post connections configured to receive one or more wall posts.

17. The modular vehicle system of claim 16, further comprising a fabric enclosure configured to be operably coupleable to the wall posts to form a partial enclosure of the deck assembly.

18. The modular vehicle system of claim 18, wherein the partial enclosure includes both an opaque layer and a mosquito netting layer, with one or more zippers to selectively open or establish various configurations of the partial enclosure.

19. The modular vehicle system of claim 12, further comprising an x-tray panel configured to slide and pivot relative to the deck plate.

20. The modular vehicle system of claim 20, wherein the x-tray panel is configured at least one of slide or pivot to be at least partially in contact with a floor of the vehicle and to form a ramp between a ground surface and the deck plate.
